(19) United States
(12) Patent Application Publication
(10) Pub. No.: US 2019/0318407 A1
(43) Pub. Date: Oct. 17, 2019

(54) METHOD FOR PRODUCT SEARCH USING THE USER-WEIGHTED, ATTRIBUTE-BASED, SORT-ORDERING AND SYSTEM THEREOF

(71) Applicant: Devanathan Giridhari, (US)

(72) Inventors: Devanathan Giridhari, Mugalivakkam, Chennai (IN); Ramakrishnan Shyamsunder, Chembur, Mumbai (IN); Sachan Devendra Singh, Kondapur, Hyderabad (IN)

(21) Appl. No.: 15/749,862

(22) PCT Filed: Sep. 1, 2015
(86) PCT No.: PCT/IN2015/000342

§ 371 Date: Feb. 2, 2018

(30) Foreign Application Priority Data
Jul. 17, 2015 (IN) 3691/CHE/2015

(51) Int. Cl. G06Q 30/06; G06F 16/9538; G06F 16/2457; G06F 16/9535; G06Q 30/02; G06N 20/00

(52) U.S. Cl. CPC G06Q 30/0627; G06F 16/9538; G06F 16/24578; G06N 20/00; G06Q 30/0282; G06Q 30/0629; G06F 16/9535

(57) ABSTRACT

A computer-implemented method for product search using the User-Weighted, Attribute-Based, Sort-Ordering comprising the steps of: computing of specification score for product attribute; computing of sentiment score for product attribute; characterized by steps of: —extracting reviews for each product from multiple sources; detecting the attributes described in each product review; detecting the polarity (positive/negative) of the user review with respect to each attribute converting the said attributes into a numerical score for each attribute which captures all the information about that attribute from user-ratings; computing an overall product score using the specifications score and sentiment score for individual product attributes; and displaying the search results sorted according to the overall product score.

### FIELD OF THE INVENTION

This invention pertains in general to mining of information from product reviews in electronic commerce and more particularly to a method and a system for providing a comprehensive product overview/search using user-weighted attribute-based sort-ordering of products.

### DESCRIPTION OF THE RELATED ART

Products are often discussed in public reviews, online and in other media. Reviews are typically written by professional critics, by experts, and/or by ordinary consumers. Reviews often discuss particular features of a reviewed item, and provide the reviewer's subjective opinions regarding the item (product or service) and its features. A rating may be given as part of a review, to indicate an item's relative merit. e-commerce websites often provide a facility to write a product review on their sites, giving consumers a chance to rate and comment on products they have purchased. Such reviews are published near or on the web page(s) that offer the reviewed product. Users can also rate products (a star-based rating system is provided). Other consumers can read these reviews when considering items for purchase. When several reviews have been given, an overall rating based on the individual ratings can be calculated and displayed on the product page.

Internet product searches are used to help Web users research and buy products. With the widespread growth of Internet use, the Internet (such as blog, forum, etc.) has produced a large number of users to participate and comment on products, events and provide other review information. These comments often express a variety of user information and emotional colors and emotional tendency, which not only provides an information display platform for businesses, but also for the consumer (ie the user) provides a platform for the exchange of product experience. Extracting information and meaning from these massive texts with this kind of emotion, using text sentiment analysis and language processing, and converting it into a instantly comprehensible representation (like a numerical score—sentiment score) has a strong business and customer value, for example, the user can review for information commodity goods, choose the right product; businesses can use data gleaned from user reviews to improve product quality, and strive for greater market share.

A basic task of sentiment analysis is the text sentiment classification into positive or negative text. Another task is to identify entities and attributes within it, and the larger goal within the product review context is to mine all the relevant information and convert it into an easily understood metric about the product (like a numerical score).

A number of product search systems currently exist—many companies (e.g. Google, Microsoft) have search engines with a variety of different product search systems by crawling websites of e-retailers. Also, vertical search engines exist that provide a plethora of search options.

In both product search and online shopping systems, a common function is to rank products according to the preference of end users. Since most of these Web sites allow users to give rating scores (typically from 1 to 5 stars) for products, the typical product ranking approach is based on the average score of all ratings given by end users for each product.

The search process for products with many attributes, and many variants at different price points is complex. All the existing approaches for product search at e-Commerce websites and shopping comparison websites implement product attribute-based filtering to aid the product search and discovery process. This has certain drawbacks—it does not provide a comprehensive product overview, it does not consider products holistically (products at the boundary are eliminated) and it does not customise according to user preferences.

In a prior art an U.S. Pat. No. 8,892,422 discloses methods of phrase identification, using identification of a phrase weighting of a sequence of words as a function of the position of words present in the sequence of words and apparatus thereof. Methods are provided herein to help determine the co-occurrence consistencies for positional word pairings of a variety of word sequences in a corpus that may be used in identifying a phrase; determining a phrase coherence of a word sequence based on the co-occurrence consistencies for positional word pairings in the word sequence; and determining one or more phrase boundaries in a word sequence.

Another prior art, an U.S. Pat. No. 5,696,962 discusses method for computerized information retrieval from a text corpus in response to a natural-language input string, e.g., a question, supplied by a user. A string is accepted as input and analyzed to detect noun phrases and other grammatical constructs therein. The analyzed input string is converted into a series of Boolean queries based on the detected phrases. US Specification U.S. Pat. No. 9,037,464 B1 (Computing Numeric Representations of words in a high-dimensional space) discusses techniques to obtain a respective numeric representation of each word in the vocabulary in the high-dimensional space.

In the prior art following non patent literature has been referred:
1. Arthur. D and Vassilvitskii, S. “k-means++: the advantages of careful seeding”. ACM-SIAM symposium on Discrete algorithms. 2007
2. C. D. Manning, P. Raghavan and H. Schütze, Introduction to Information Retrieval. Cambridge University Press, pp. 234-265. (2008)
3. D. Gillick, Sentence Boundary detection and the problem with U.S., NAACL (2009)
4. http://nlp.stanford.edu/IR-book/html/htmledition/spelling-correction-1.html
5. Mikolov. T, et al, Distributed Representation of Words and Phrases and their compositionality. NIPS 2013.

### Disadvantages in the Existing Approach

Lack of Comprehensive Overview of a Product:

It is possible to get a comprehensive overview of the quality of a product by analysing along two dimensions—one based on the technical specifications of the product, and another based on what the users of the products are saying about it. Existing approaches to product search do not provide a useful summarisation of user reviews, at the most, they provide only a listing of user reviews from their own sites. Users are forced to navigate hundreds of reviews for each product on multiple website and then assimilate all this information. It is very difficult to condense all this information into a single representative metric that provides an overview of the product. Since it is not possible to easily obtain a representative metric that conveys the quality of the product as gleaned from user reviews, it is therefore not possible to get a comprehensive overview of a product—it can be rated only on the basis of its technical specifications.

Arbitrary Elimination of Products—

Filtering applies an arbitrary boundary and excludes all products that fall just outside the boundary. (For e.g. camera resolution [in megapixels] is a common filter used to simplify search for smartphones. However, applying a filter at 8MP and above for the camera arbitrarily excludes phones that may have had a very good camera with 7.9 MP resolution).

Lack of Customisation—

Different users attach different levels of importance to various product attributes. The filtering mechanism does only a binary selection/elimination and does not allow users to attach varying levels of importance to different attributes. (E.g.—If battery life is the most important criteria for me, followed by camera quality, and if screen size does not matter at all, then the search results should sort records in such a way that phones with the best battery life appear higher than others). The filtering mechanism does not allow for this.

The discussion above is merely provided for general background information and is not intended for use as an aid in determining the scope of the claimed subject matter.

### SUMMARY OF INVENTION

Systems and methods in accordance with various embodiments of the present invention can provide for the information mining via language processing of product reviews in electronic commerce. For products with many attributes and many variants, the buying decision involves a lot of complex research because—
Product is complex—Many attributes to consider (e.g.—battery, camera, display, performance, brand etc. for smartphone)
Decision is complex—Many products to consider (e.g—many manufacturers, many brands, many variants—for smartphone).

Therefore herein described there is provided a computer-implemented system and method for product search using the User-Weighted, Attribute-Based, Sort-Ordering comprising the steps of: computing of specification score for product attribute; computing of sentiment score for product attribute; characterized by steps of extracting reviews for each product from multiple sources; detecting the attributes described in each product review; detecting the polarity (positive/negative) of the user review with respect to each attribute and converting the detected information into a numerical score for each attribute which captures all the information about that attribute from user-ratings; computing the overall product score based on specification score and sentiment score of individual product attributes; and displaying the search results sorted according to the overall product score.

In some embodiments, the present invention provides a computerized system and method for searching, analyzing, and display data using an User-Weighted Attribute-Based Sort-Ordering algorithm. More particularly the present invention provides a solution to personalize relevant data using a user-defined, user weighted, and a user-profile-driven method to obtain relevant data and feedback tuning for searching, comparing, and analysing data as product review.

In some embodiments, the present invention provides a novel approach to product search that overcomes the drawbacks of the existing method by doing the following—
Provide a comprehensive product overview: The comprehensive product overview is defined as an amalgamation of the technical specifications (what the manufacturers say) and all the user reviews (what users say) about a product. The product overview incorporates both technical specifications and user opinions and reviews. The invention uses a proprietary ‘sentiment engine’ that parses thousands of user reviews for each product and decodes their meaning and converts it into a numerical score that represents the user rating for each product. The user rating is combined with technical specifications to arrive at an overall product score.
Provide a sort-ordering and ranking based approach to product search: instead of filtering on product attributes and eliminating products at the boundary, the users are allowed to select the level of importance they ascribe to multiple product attributes. The user-weighted attribute-based sort ordering provides superior search results as compared to filtering and elimination because—
   It takes all products into consideration, instead of arbitrarily eliminating some of them.
   It personalizes the search results based on user preferences—by letting the user set weights to the product attributes.

Some embodiments further include enabling user defined relevant information in the form of input data or feedback. Other embodiments enable and facilitate sharing of data and user defined and user weighted feedback and decisions with regards to purchasing, evaluating, comparing, predicting, searching and browsing a particular product, individual event or other user-defined topic. The new approach has the following advantages
Holistic product overview—By considering both, manufacturer's ratings and user reviews from the world wide web, the new approach provides a holistic overview of every product.
Better product selection—Sort ordering takes all products into consideration and does not eliminate products at arbitrary boundaries. This approach takes all the attributes of the product into consideration and therefore, a more holistic ranking of products.
Customization—Users are allowed to assign different weights to individual product attributes, leading to a more personalized search—that is not possible under the existing methods.

### BRIEF DESCRIPTION OF THE ACCOMPANYING DRAWINGS

FIG. 1 illustrates GUI of an e-commerce site showing the four main product attributes in case of smartphones as an example in accordance with the present invention;

FIG. 2 illustrates GUI of an e-commerce site showing the User-defined weights for different product attributes as an example in accordance with the present invention;

FIG. 3 illustrates GUI of an e-commerce site showing the Product Search results, based on user weighted attributes, Comprehensive product score: Buysmaart Score=Average of Sentiment Score and Specifications Score as an example in accordance with the present invention;

FIG. 4 illustrates GUI of an e-commerce site allowing user to change attribute preferences and modify results according to new criteria—observe the difference between the search results based on different criteria as an example in accordance with the present invention;

### DETAILED DESCRIPTION

Such as herein described there is provided a method and system configured for comprehensive product search and overview using user weighted attribute based sort ordering. The disclosed sort ordering takes all products into consideration and does not eliminate products at arbitrary boundaries. The improved method encompasses all the attributes of the product into consideration and therefore, is considered as a more holistic ranking of products.

The users are allowed to assign different weights to individual product attributes, leading to a more personalized search, also accommodating all possible variables/varieties of products. —This is not possible under the existing methods.

As per an exemplary embodiment, the system architecture includes a processing unit, typically a computer for use as a user and/or server according to one embodiment. Illustrated are at least one processor coupled to a bus. Also coupled to the bus are a memory, a storage device, a key board, a graphics adapter, a pointing device, and a network adapter. A display is coupled to the graphics adapter.

The processor may be any general-purpose processor. The results may be stored in the memory, and the method comprises storing the real result. The results may be stored in any memory, and may be stored in a volatile, or preferably non-volatile memory. They may be stored using any suitable data storage medium or media. In particularly preferred embodiments the results are stored using a set of one or more memory drives. Any suitable drive may be used, but preferably the or each drive is a solid state drive (SSD). Such drives have been found to be particularly useful for storing result tables, as SSDs may provide fast access to stored. The pointing device may be a mouse, track ball, or other type of pointing device, and is used in combination with the keyboard to input data into the computer system. The graphics adapter displays images and other information on the display. The network adapter couples the computer to a network.

As is known in the art, the computer is adapted to execute computer program modules stored in memory. As used herein, the term “module” refers to computer program logic and/or data for providing the specified functionality. A module can be implemented in hardware, firmware, and/or software. In one embodiment, the modules are stored on the storage device, loaded into the memory, and executed by the processor.

Relevant pieces of the information are extracted from the data retrieved from the diverse set of sources and stored. Product information gathered by aggregation may be normalized into a single unified representation, which is described in detail below. Each product is associated with a product category as well as with the information collected about the product. The processing of the information obtained from different information sources across numerous product categories is challenging since there is no single representational standard used across web sites for representing the information and the information is constantly changing. The accuracy of the analysis of the quality of a product typically improves with the volume and diversity of data used for processing. More, diverse data results in better estimation of customer satisfaction, sentiment and better coverage of products across the internet.

Systems and methods in accordance with various embodiments of the present invention can overcome the aforementioned and other deficiencies in existing product review approaches by providing a different approach to product search, based on the following key insights.
A comprehensive product overview can be created by analysing product reviews from all over the internet, and deriving the meaning out of them using machine learning, natural language processing and sentiment analysis techniques.
When products attributes lie on along a spectrum of values, filtering is not the best approach to sort good products from bad ones. (E.g. when Camera Mega Pixel values lie along a continuum from 2MP to 41MP, drawing 8MP as the dividing line between good and bad cameras leads to an incorrect classification for a camera of 7.9MP.)
When products have multiple attributes, the weight ascribed to an individual attribute varies (depends on the individual buyer) and therefore, there needs to be a method for user-weighted ranking of attributes to produce more personalized product search results.

The sentiment analysis engine analyses millions of user reviews, extracts meaning from these reviews, produces a numerical score for each product that encapsulates the user-reviews for that product (more positive the reviews, higher would be the score).

### User-Weighted Attribute-Based Sort-Ordering for Product Search

There are n Products in a set {P1 . . . Pr}.

Each of these products has r Attributes i.e. all products {P1 . . . Pn} have r attributes in the set {A1 . . . Ar}. The possible set of product-attribute combinations is (n×r).

Each attribute of these r Attributes has any number of discrete possible values along a spectrum from Ai(min) to Ai(max) where Ai(min) and Ai(max) are the minimum and maximum values for the attribute Ai.

There is a user u, that assigns a weight Wi to every attribute Ai in the set {A1 . . . Ar}. Every attribute Ai in the set {A1 . . . An} is given a weight Wi that can vary in a discrete set of weight values from {Wmin . . . Wmax}

Our user-weighted Attribute-based Sort-Ordering for Product Search ranks the n products in descending order of their Product Scores. The product score is computed as a weighted sum of the individual attribute scores (weights are assigned by the user).

Each attribute score is computed as a weighted average of the specifications score, and sentiment score for the attribute. The specifications score is based on the technical specifications as suggested by the manufacturers, while the sentiment score is based on analysis of the text of the review for the product.

For e.g. Product Score for mobile phone P1 will be weighted sum of attribute scores for display, camera, screen size and performance—where weights will be specified by the user each of the four attributes to denote the importance of those attributes. Scores of the attributes themselves will be weighted averages of the specification score for the attribute (rank-normalized) and the sentiment score for the attribute (numerical score based on sentiment analysis).

The process therefore has the following two steps:

Step 1: Computation of standardized scores for individual product attributes
This step can be divided into two parts—

A. Computation of specification score for product attribute

B. Computation of sentiment score for product attribute

Part a—Computation of Specification Score for Product Attributes
Since individual attributes are not comparable (e.g. camera---->MegaPixel, is not comparable to battery--->maH), it is necessary to standardize the individual attribute scores in order to enable the addition of attribute scores. This is achieved using normalization and percentile based scaling.
Part B—Computation of sentiment score for product attributes.
This involves the following steps
Extracting reviews for each product from multiple sources (e-commerce websites, gadget websites etc)
Detecting the attributes described in each product review
Detecting the polarity (positive/negative) of the user review with respect to each attribute
Converting the above discovered information into a numerical score for each attribute—a numerical score that captures all the information about that attribute from user-ratings

Further details of the sentiment score computation are given here.

### Output of Step 1—Individual Attribute Score:

sa(i)=standardized score (between 0 and 1) for attribute Ai.
This score has two components—
the specifications score for the attribute
the sentiment score for the attribute

The specifications score for the attribute is achieved by rank normalization/min-max scaling etc. This makes it possible to add up scores that are not normally comparable.

For sentiment scores, a different methodology is used to compute scores, as outlined below.

The standardized attribute score is therefore, an average of the specification score and sentiment score for the attribute.

For phones where the sentiment score is unavailable, we apply a smoothing constant on the specifications score to arrive at the overall product score.

Therefore, for a product P1, the standardized attribute score for individual attribute Ai is denoted by s_{(P1)}a(i).

s_{(P1)}a(i)=(s_{(P1)}a_{(spec)}(i)+s_{(P1)}a₍ₛₑₙₜ₎(i))/2

where S_{(P1)}a_{(spec)}(i) is the specification score for attribute a(i) of product P1 and S_{(P1)}a₍ₛₑₙₜ₎(i) is the sentiment score for the attribute a(i) of product P1.
Step 2: Calculating the overall product scores by summing up the standardized attribute scores, with user-weighted criteria, to derive user-specific product score.

S_{(Pj) for user u}=Σᵢ₌₁^{T}wᵤ(i)S_{(Pj)}a(i)
Here—S_{(Pj)}=Total Score for Product j, as determined for user u

This is expressed as weighted summation of scores for the r individual attributes of Pj. Where s_{(Pj)}a(i) is the standardized attribute score for individual attribute a(i) of Product j. Wᵤ(i) is the weight assigned by user u to the attribute i.

Following can be noted from above equation
Computing the user-weighted total scores S_{(Pj)} for all products from P1 to Pn will allow us to rank all products based on user preferences for attributes. These scores can be sorted in descending order and displayed on a user-interface to allow easy, relevant and personalized product discovery.
Users can customise their search and discover different products by varying the weights they attach to individual attributes.

### Working Examples

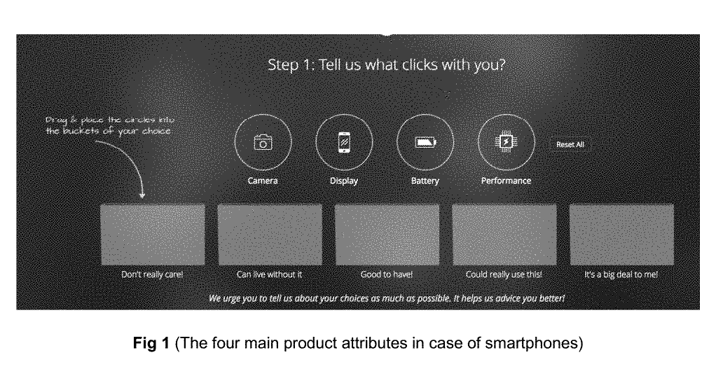

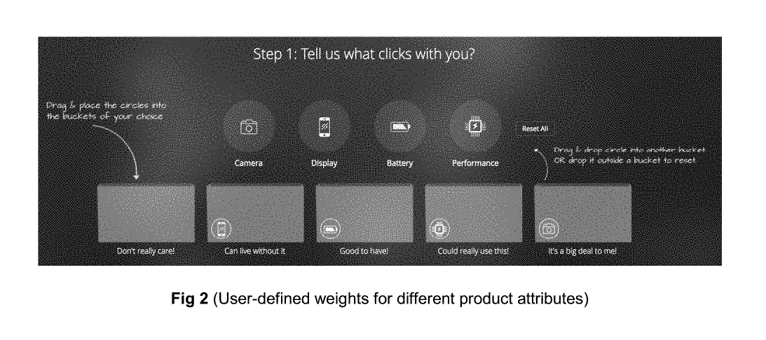

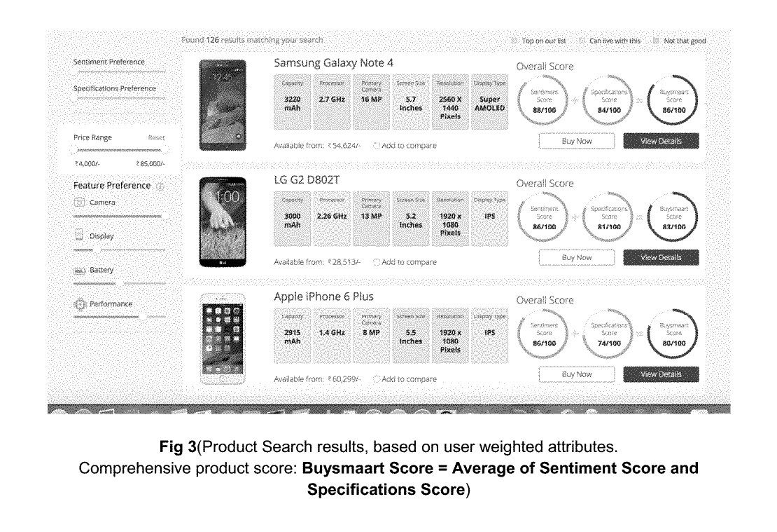

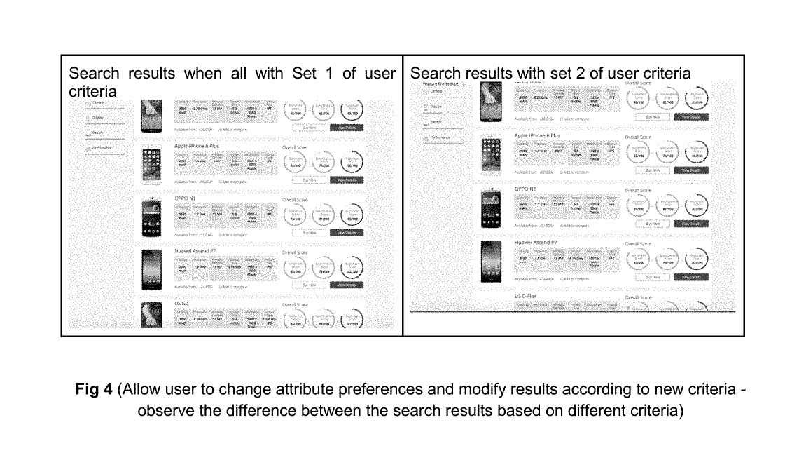

Smartphone Search.
1. There are four attributes that people search for—A1, to A4, namely Camera, Display, Battery Life and Performance as shown in FIG. 1.
2. There are over 100s of products which have different values for these four attributes.
3. Create normalized scores for each product attribute. Take camera MegaPixel values (and any other evaluation parameters), rank-normalise them, and convert the individual attribute values into Camera attribute scores for each Product. Do this process similarly for display, battery life and performance. We now have individual product attribute scores which can be added to compute the overall Product Score.
4. Take user inputs—weights for each of the four different product attributes as shown in FIG. 2.
5. Compute personalized Product Score and ranking by doing a weighted addition (based on inputs from previous step) of individual product attribute scores.
6. Display the product results, with products sorted in descending order of personalized Product Scores as shown in FIG. 3.
7. Allow sliders to the user to change their preferences (i.e. change the weights assigned to different attributes) as shown in FIG. 4.

The disclosed system and method use the machine learning approaches to do sentiment analysis on user reviews and expert reviews. There are several steps involved in processing the reviews to derive a numerical score, and a brief summary of the stages in process is given below—
Pre-processing of reviews—Pre-processing of data is often less appreciated part, but it is very important for the later stages.
   a. Removing duplicate reviews, i.e. remove multiple reviews which have the same review text and review id and belong to the same product.
   b. Language identification is carried out to filter out the which are not written in English.
   c. A supervised classifier is learned using Naive Bayes algorithm for sentence boundary detection to split the review to its individual sentences. One reference of this work is according to [D. Gillick, Sentence Boundary detection and the problem with U.S., NAACL (2009)]
   d. Tokenizing of the sentences to remove non-English characters, separate punctuation characters from words etc. Spelling corrections are also done for the misspelled words as per the URL[http://nlp.stanford.edu/IR-book/html/htmledition/spelling-correction-1.html]
Creation of sentiment and aspect lexicons—The present invention proposes aspect based sentiment analysis on user reviews using machine learning and natural language processing. Supervised machine learning algorithms need labelled data for training. The steps to generate labelled training data in semi-supervised setting are as below:
   a. The keywords are extracted for all sentiments and aspect classes from reviews to build lexicon files. These lexicons are used to do data annotation in reviews.
   b. The keyword phrases are extracted from the reviews corpus using unsupervised statistical language modelling techniques by identifying a phrase weighting of a sequence of words as a function of the position of words present in the sequence of words.
   c. A representation of words and phrases in vector space commonly known as word embeddings are generated as per [Mikolov. T, et al, Distributed Representation of Words and Phrases and their compositionality, NIPS 2013].
   d. To grow the said aspect lexicons, a semantic graph is constructed, using the cosine similarity between words and phrases embeddings as the similarity criterion. Few seed words are used from each class to come up with more similar keywords using similarity based graph propagation algorithm.
   e. After several iterations of graph propagation algorithm, a majority of the aspect and sentiment based keywords can be extracted.
Data annotation (labelling) using above keywords—The said lexicons are used from every class to annotate the review sentences as below:
   a. In every review sentence, the presence of aspect and sentiment words are searched. After parsing the sentence, the sentiment word which is closest to the aspect word is selected and the sentence is tagged with the corresponding aspect, sentiment tuple.
   b. In case if multiple similar tags gets associated with a sentence, then the aspect and sentiment tags are fine-tuned, by using maximum probability score among all tags by language modelling of corresponding sentence texts.
   c. If we detect negation inducing words like {don't, can't. etc} around the surrounding context of aspect words, then the polarity of the corresponding sentiment is reverted.
   d. The annotated data is organised into its aspect class followed by its sentiment class.
Aspect and sentiment classifier—The machine learning approaches are used to predict the aspect class and sentiment class by using labelled review sentences.
   a. An aspect classifier is trained to predict the correct aspect class followed by sentiment classifier for fine grained sentiment analysis.
   b. A mixture of vector embedding is learnt for every aspect class based on generative model of sentences. The mixture of vector embedding per class is used to predict the aspect class on unseen review sentences.
   c. Those sentences which were correctly classified above are selected for training of sentiment classifier.
   d. The sentiment classification is fine grained, i.e. there are five sentiment classes which are most-positive, positive, neutral, negative, most-negative.
   e. Term-frequency, inverse document frequency, bigram and key phrases as features are used for the logistic regression based sentiment classifier.
   f. Thereafter the review sentences for which the sentiment classifier prediction agrees with the labelled data are selected for use which is commonly known as diagonal elements of the classifier confusion matrix.

### Sentiment Score Algorithm

The sentiment scoring is fine grained with five category types or classes which are most-positive, positive, neutral, negative and most-negative.
Weights are given to each of the fine grained sentiment levels in descending order of importance as below
   {most-positive:1.5, positive:1, neutral: 0, negative: −1, most-negative: −1.5}
The sentiment score of each aspect for every product is computed by aggregating the weighted confidence score of the sentiment classifier for that aspect. Thereafter the normalization of the aggregated score is carried out by the frequency count of reviews for that aspect followed by min-max rescaling of the normalized score as below.
   do
   for ‘p’ in product:
      for ‘a’ in attribute:

$$raw score ( a , p ) = {\sum }_{reviews} I ( product = p , attribute = a ) * ( sentiment weight ) * ( confidence score )$$

$$normalized score ( a , p ) = \frac{raw score}{{\sum }_{reviews} I ( product = p , attribute = a )}$$

$$percentage score ( a , p ) = \frac{( normalised score - ( most negative ) ) * 100}{( ( most positive ) - ( most negative ) )}$$

done
Using the sentiment score of every aspect, the sentiment score of a product is calculated by the average of its aspects sentiments score as below
   do
   for ‘p’ in product:

$$sentiment score ( p ) = ( {\sum }_{a ∈ aspects} percentage score ( a , p ) \text{/} \vert aspects \vert$$

done
The total score or buysmaart score is computed for every aspects by the average of their sentiment score and specification score. Then, we average the total aspects score for all aspects to compute the total score of a product.
   do
   for ‘p’ in product:
      for ‘a’ in attribute:
         if (sentiment score(a,p) exists:

total score(a,p)=(sentiment score(a,p)+specification score (a,p))/2
else:

total score (a,p)=(specification score(a,p)*sentiment smoothing (p))

total score (p)=(Σ_{aϵaspects} total score(a,p)/|aspects|
done

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What claimed is:

1. A computer-implemented method for product search using the User-Weighted, Attribute-Based, Sort-Ordering comprising the steps of:
computing of specification score for product attribute;
computing of sentiment score for product attribute; characterized by steps of:—
extracting reviews for each product from multiple sources;
detecting the attributes described in each product review;
detecting the polarity (positive/negative) of the user review with respect to each attribute
converting the said attributes into a numerical score for each attribute which captures all the information about that attribute from user-ratings;
computing an overall product score using the specifications score and sentiment score for individual product attributes; and
displaying the search results sorted according to the overall product score.

2. The method as claimed in claim 1, wherein the specifications score for the attribute is achieved by rank normalization/min-max scaling.

3. The method as claimed in claim 1, wherein the standardized attribute score is an average of the specification score and sentiment score for the attribute.

4. The method as claimed in claim 1, wherein under condition that the sentiment score is unavailable, then a smoothing constant is applied on the specifications score to arrive at the overall product score.

5. The method as claimed in claim 1, wherein the standardized attribute score for individual attribute is calculated as:
Ai is denoted by s_{(P1)}a(i).
s_{(P1)}a(i)=(s_{(P1)}a_{(spec)}(i)+s_{(P1)}a₍ₛₑₙₜ₎(i))/2,
where S_{(P1)}a_{(spec)}(i) is the specification score for attribute a(i) of product P1 and S_{(P1)}a₍ₛₑₙₜ₎(i) is the sentiment score for the attribute a(i) of product P1.

6. The method as claimed in claim 1, wherein the step of calculating the overall product scores is carried out by summing up the standardized attribute scores, with user-weighted criteria, to derive user-specific product score using formula:
S(Pj) for user u=Σᵢ₌₁^{T}wᵤ(i)S_{(Pj)}a(i)
Here—S(Pj)=Total Score for Product j, as determined for user u
as weighted summation of scores for the r individual attributes of Pj;
Where s(Pj)a(i) is the standardized attribute score for individual attribute a(i) of Product j and Wᵤ(i) is the weight assigned by user u to the attribute i.

7. The method as claimed in claim 1, wherein the sentiment score computation use the machine learning approach to do sentiment analysis on user reviews and expert reviews.

8. The method as claimed in claim 1, wherein the sentiment computation includes steps of:
pre-processing of reviews;
creating of sentiment and aspect lexicons;
data annotation (labelling) using the aspect lexicons; and
classifying of the aspect and sentiment by using labelled review sentences.

9. The method as claimed in claim 8, wherein the step of pre-processing of reviews includes the further steps of:
a. removing of the duplicate reviews;
b. carrying of language identification for filtering out the words/statements which are not written in English.
c. classifying using Naive Bayes algorithm which is operationalized for sentence boundary detection and split the review to its individual sentences.
d. tokenizing of the sentences to remove non-english characters, separate punctuation characters from words etc and spelling corrections for the misspelled words.

10. The method as claimed in claim 8, wherein the step of creating of sentiment and aspect lexicons includes the further steps of:
extracting the keywords for all sentiments and aspect classes from reviews to build lexicon files;
extracting the keyword phrases from the reviews corpus using unsupervised statistical language modelling techniques;
generating of the representing words and phrases in vector space commonly known as word embeddings;
constructing of a semantic graph to grow the said aspect lexicons using the cosine similarity between words and phrases embeddings as the similarity criterion using a few seed words from each class to come up with more similar keywords using similarity based graph propagation algorithm; and
carrying out several iterations of graph propagation algorithm from where a majority of the aspect and sentiment based keywords are extracted.

11. The method as claimed in claim 8, wherein the step of Data annotation (labelling) using keywords includes the steps of:
searching of the aspect and sentiment words;
parsing the sentence to extract the sentiment word which is closest to the aspect word and thereafter the sentence is tagged with the corresponding aspect, sentiment tuple;
wherein under condition that multiple similar tags gets associated with a sentence, then the aspect and sentiment tags are fine-tuned, by using maximum probability score among all tags by language modelling of corresponding sentence texts;
wherein under condition that negation inducing words like {don't, can't. etc} are detected around the surrounding context of aspect words, then the polarity of the corresponding sentiment is reverted; and
organising the annotated data into its aspect class followed by its sentiment class.

12. The method as claimed in claim 1, wherein the step of classifying the aspect and sentiment is carried out by a classifier using the machine learning approaches to predict the aspect class and sentiment class by using labelled review sentences including further steps of:
training of an aspect classifier to predict the correct aspect class followed by sentiment classifier for fine grained sentiment analysis;
learning of mixture of vector embedding for every aspect class based on generative model of sentences;
selecting the sentences which are correctly classified for training of sentiment classifier;
carrying out fine graining of the sentiment classification;
using Term-frequency, inverse document frequency, bigram and key phrases as features for the logistic regression based sentiment classifier; and
reviewing of the sentences for which the sentiment classifier prediction agrees with the labelled data are selected for further use.

13. The method as claimed in claim 12, wherein the mixture of vector embedding per class is used to predict the aspect class on unseen review sentences.

14. The method as claimed in claim 12, wherein the sentiment scoring is fine grained with five category types or classes which are most-positive, positive, neutral, negative and most-negative.

15. The method as claimed in claim 12, wherein the sentiment score of each aspect for every product is computed by aggregating the weighted confidence score of the sentiment classifier for that aspect and thereafter the normalization of the aggregated score is carried out by the frequency count of reviews for that aspect followed by min-max rescaling of the normalized score.

16. A system for product search using the User-Weighted, Attribute-Based, Sort-Ordering, comprising of:
at least one processor;
at least one non-transitory computer readable medium storing instructions translatable by the at least one processor to implement the steps of:
computing of specification score for product attribute;
computing of sentiment score for product attribute; characterized by steps of:—
extracting reviews for each product from multiple sources;
detecting the attributes described in each product review;
detecting the polarity (positive/negative) of the user review with respect to each attribute converting the said attributes into a numerical score for each attribute which captures all the information about that attribute from user-ratings;
compute an overall product score by combining the specifications and sentiment scores of individual attributes and displaying the search results sorted according to the overall product score.

17. The system as claimed in claim 16, wherein the specifications score for the attribute is achieved by rank normalization/min-max scaling.

18. The system as claimed in claim 16, wherein the standardized attribute score is an average of the specification score and sentiment score for the attribute.

19. The system as claimed in claim 16, wherein under condition that the sentiment score is unavailable, then a smoothing constant is applied on the specifications score to arrive at the overall product score.

20. The system as claimed in claim 16, wherein the standardized attribute score for individual attribute is calculated as:
Ai is denoted by s_{(P1)}a(i).
s_{(P1)}a(i)=(s(P1)a(spec)(i)+s(P1)a(sent)(i))/2,
where S(P1)a(spec)(i) is the specification score for attribute a(i) of product P1 and S(P1)a(sent)(i) is the sentiment score for the attribute a(i) of product P1.

21. The system as claimed in claim 16, wherein the step of calculating the overall product scores is carried out by summing up the standardized attribute scores, with user-weighted criteria, to derive user-specific product score using formula:
S(Pj) for user u=Σᵢ₌₁^{T}wᵤ(i)S_{(Pj)}a(i)
Here—S(Pj)=Total Score for Product j, as determined for user u
as weighted summation of scores for the r individual attributes of Pj;
Where s(Pj)a(i) is the standardized attribute score for individual attribute a(i) of Product j and Wu(i) is the weight assigned by user u to the attribute i.

22. The system as claimed in claim 16, wherein the sentiment score computation use the machine learning approach to do sentiment analysis on user reviews and expert reviews.

23. The system as claimed in claim 16, wherein the sentiment computation includes steps of:
pre-processing of reviews;
creating of sentiment and aspect lexicons;
data annotation (labelling) using the aspect lexicons; and
classifying of the aspect and sentiment by using labelled review sentences.

24. The system as claimed in claim 23, wherein the step of pre-processing of reviews includes the further steps of:
a. removing of the duplicate reviews;
b. carrying of language identification for filtering out the words/statements which are not written in English.
c. classifying using Naive Bayes algorithm which is operationalized for sentence boundary detection and split the review to its individual sentences.
d. tokenizing of the sentences to remove non-english characters, separate punctuation characters from words etc and spelling corrections for the misspelled words.

25. The system as claimed in claim 23, wherein the step of creating of sentiment and aspect lexicons includes the further steps of:
extracting the keywords for all sentiments and aspect classes from reviews to build lexicon files;
extracting the keyword phrases from the reviews corpus using unsupervised statistical language modelling techniques;
generating of the representing words and phrases in vector space commonly known as word embeddings;
constructing of a semantic graph to grow the said aspect lexicons using the cosine similarity between words and phrases embeddings as the similarity criterion;
using a few seed words from each class to come up with more similar keywords using similarity based graph propagation algorithm; and
carrying out several iterations of graph propagation algorithm from where a majority of the aspect and sentiment based keywords are extracted.

26. The system as claimed in claim 23, wherein the step of Data annotation (labelling) using keywords includes the steps of:
searching of the aspect and sentiment words;
parsing the sentence to extract the sentiment word which is closest to the aspect word and thereafter the sentence is tagged with the corresponding aspect, sentiment tuple;
wherein under condition that multiple similar tags gets associated with a sentence, then the aspect and sentiment tags are fine-tuned, by using maximum probability score among all tags by language modelling of corresponding sentence texts;
wherein under condition that negation inducing words like {don't, can't. etc} are detected around the surrounding context of aspect words, then the polarity of the corresponding sentiment is reverted; and
organising the annotated data into its aspect class followed by its sentiment class.

27. The system as claimed in claim 16, wherein the step of classifying the aspect and sentiment is carried out by a classifier using the machine learning approaches to predict the aspect class and sentiment class by using labelled review sentences including further steps of:
training of an aspect classifier to predict the correct aspect class followed by sentiment classifier for fine grained sentiment analysis;
learning of mixture of vector embedding for every aspect class based on generative model of sentences;
selecting the sentences which are correctly classified for training of sentiment classifier;
carrying out fine graining of the sentiment classification;
using Term-frequency, inverse document frequency, bigram and key phrases as features for the logistic regression based sentiment classifier; and
reviewing of the sentences for which the sentiment classifier prediction agrees with the labelled data are selected for further use.

28. The system as claimed in claim 27, wherein the mixture of vector embedding per class is used to predict the aspect class on unseen review sentences.

29. The system as claimed in claim 27, wherein the sentiment scoring is fine grained with five category types or classes which are most-positive, positive, neutral, negative and most-negative.

30. The system as claimed in claim 27, wherein the sentiment score of each aspect for every product is computed by aggregating the weighted confidence score of the sentiment classifier for that aspect and thereafter the normalization of the aggregated score is carried out by the frequency count of reviews for that aspect followed by min-max rescaling of the normalized score.
